(19) United States
(12) Patent Application Publication
(10) Pub. No.: US 2026/0162519 A1
(43) Pub. Date: Jun. 11, 2026

(54) SELF-TESTING MANUAL INITIATING DEVICE

(71) Applicant: Honeywell International Inc., Charlotte, NC (US)

(72) Inventors: Benjamin Henry Wolf, Leicester (GB); Scott Robert Lang, Geneva, IL (US); Michael Barson, Nuneaton (GB)

(21) Appl. No.: 18/973,653

(22) Filed: Dec. 9, 2024

(51) Int. Cl. G08B 29/12

(52) U.S. Cl. CPC G08B 29/12

(57) ABSTRACT

Self-testing manual initiating devices are described herein. One self-testing manual initiating device includes a switch configured to activate a fire alarm system, an actuator coupled to the switch configured to activate the switch, and a controller configured to receive a command to test the self-testing manual initiating device and transmit a command to the actuator to activate the switch in response to receiving the command to test the self-testing manual initiating device.

### TECHNICAL FIELD

The present disclosure relates generally to self-testing manual initiating device.

### BACKGROUND

Large facilities (e.g., buildings), such as commercial facilities, office buildings, hospitals, and the like, may have a fire alarm system that can be triggered during an emergency situation (e.g., a fire) to warn occupants to evacuate. For example, a fire alarm system may include a fire control panel, a plurality of fire sensing devices (e.g., smoke detectors) and a plurality of manual initiating devices (e.g., call points or pull stations) located throughout the facility (e.g., on different floors and/or in different rooms of the facility) that can be triggered by an occupant to trigger a notification of a fire to other occupants of the facility via alarms.

Maintaining the fire alarm system can include regular testing of fire sensing devices and manual initiating devices mandated by codes of practice in an attempt to ensure that the fire sensing devices and manual initiating devices are functioning properly. However, in order to test manual initiating devices, the fire alarm system or zones of the fire alarm system are isolated and placed in a test mode. This can compromise the safety of the building and its inhabitants as occupants, maintenance engineers, and/or first responders cannot tell if a real fire event is occurring in the isolated area during the testing.

### BRIEF DESCRIPTION OF THE DRAWINGS

FIG. 1 illustrates a block diagram of a self-testing manual initiating device in accordance with an embodiment of the present disclosure.

FIG. 2 illustrates an example of a self-testing manual initiating device in accordance with an embodiment of the present disclosure.

FIG. 3 illustrates an example of an interior of a self-testing manual initiating device in accordance with an embodiment of the present disclosure.

FIG. 4 illustrates a block diagram of a fire control panel in accordance with an embodiment of the present disclosure.

FIG. 5 illustrates a fire control system in accordance with an embodiment of the present disclosure.

### DETAILED DESCRIPTION

Self-testing manual initiating devices (e.g., initiating devices) are described herein. One initiating device includes a switch configured to activate a fire alarm system, an actuator coupled to the switch configured to activate the switch, and a controller configured to receive a command to test the initiating device and transmit a command to the actuator to activate the switch in response to receiving the command to test the initiating device.

Previous initiating devices require a fire alarm system or zones including a plurality of initiating devices of the fire alarm system to be isolated to test a single initiating device. This prevents the fire alarm system or the isolated zone of the fire alarm system from detecting a real fire if a fire starts during the test. Further, a person (e.g., maintenance engineer and/or operator) has to manually test each initiating device, for example, by manually activating a switch or turning a key, which can be a difficult, time-consuming process.

In contrast, initiating devices in accordance with the present disclosure can include an actuator to activate a switch or turn a key in response to receiving a command to test the initiating device. Further, a single initiating device can be placed in a test mode while the rest of the fire alarm system can remain active to detect a real fire. Accordingly, testing initiating devices in accordance with the present disclosure can be safer, easier, and/or quicker than testing previous initiating devices.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that mechanical, electrical, and/or process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

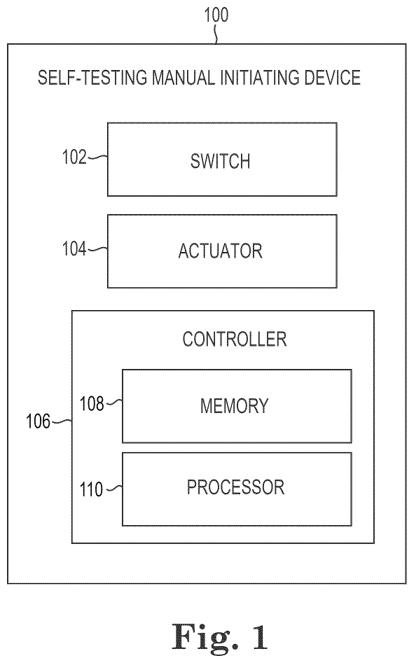

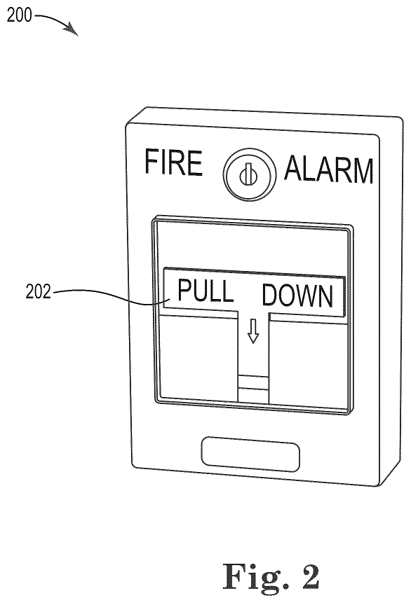

The figures herein follow a numbering convention in which the first digit or digits correspond to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2.

As used herein, “a”, “an”, or “a number of” something can refer to one or more such things, while “a plurality of” something can refer to more than one such things. For example, “a number of components” can refer to one or more components, while “a plurality of components” can refer to more than one component.

FIG. 1 illustrates a block diagram of a self-testing manual initiating device 100 in accordance with an embodiment of the present disclosure. The initiating device 100 includes a switch 102, an actuator 104, and a controller (e.g., microcontroller) 106. The initiating device 100 can be a component of a fire alarm system of a facility (e.g., building). In some examples, the initiating device 100 can be a pull station or can include a glass element to break in order to sound a fire alarm and/or initiate an evacuation of the building. The actuator 104 can be, but is not limited to, a solenoid, a linear actuator, a non-linear actuator, a servo motor, or a stepper motor, for example.

The controller 106 can include a memory 108 and a processor 110. Memory 108 can be any type of storage medium that can be accessed by processor 110 to perform various examples of the present disclosure. For example, memory 108 can be a non-transitory computer readable medium having computer readable instructions (e.g., computer program instructions) stored thereon that are executable by processor 110 to perform a self-test in accordance with the present disclosure. For instance, processor 110 can execute the executable instructions stored in memory 108 to receive a command to test the initiating device 100 and transmit a command to the actuator 104 to activate the switch 102 and/or associated mechanical parts in response to receiving the command to test the initiating device 100. In some examples, the initiating device 100 can be in test mode prior to the controller 106 receiving the command to activate the switch 102.

In a number of embodiments, the switch 102 can move from a non-active position in which the switch 102 is inside an opening of the initiating device 100 to an active position in response to the actuator 104 activating the switch 102. A portion of the switch 102 can protrude from the initiating device 100 when the switch 102 is in the active position. In some examples, the switch 102 can be a pull switch.

The controller 106 can receive a command to end the test. In response to receiving the command to end the test, the controller 106 can transmit a command to the actuator 104 to cease activation of the switch 102. The actuator 104 can move (e.g., return) the switch 102 to the non-active position in response to receiving the command to end the test and/or ceasing activation of the switch 102. In some examples, the initiating device 100 can cease the test mode in response to the actuator 104 ceasing the activation of the switch 102 and/or the switch 102 returning to the non-active position.

FIG. 2 illustrates an example of a self-testing manual initiating device 200 in accordance with an embodiment of the present disclosure. Initiating device 200 can correspond to initiating device 100 of FIG. 1. As previously described in connection with FIG. 1, the initiating device 200 can include a switch 202, which can correspond to switch 102 of FIG. 1.

In a number of embodiments, the initiating device 200 can be isolated from the other components (e.g., from the rest of) the fire alarm system in response to placing the initiating device 200 in a test mode. Isolating the initiating device 200 can prevent a false alarm. For example, activating an actuator (e.g., actuator 104 of FIG. 1) to activate the switch 202 of the initiating device 200 without having first isolated the initiating device 200 would sound a fire alarm. As such, isolating the initiating device 200 from the rest of the fire alarm system prevents a fire alarm from sounding when activating the actuator to activate the switch 202 of the initiating device 200.

Once the initiating device 200 has been tested, the initiating device 200 can be removed from the test mode and revert to a non-test (e.g., operational) mode to enable a user (e.g., person) to activate a fire alarm (e.g., subsequent to removing the initiating device 200 from the test mode, a fire alarm can be activated in response to the user activating (e.g., pulling) the switch 202). The initiating device 200 can be removed from the test mode in response to receiving a command to end the test mode, for example.

In a number of embodiments, the activation of the switch 202 can be reported. For example, the activation of the switch 202 can be reported in response to the actuator activating the switch 202. Further, a non-activation of the switch 202 can be reported. For example, in response to the actuator failing to activate the switch 202, the failure to activate the switch 202 can be reported. Further, a ceasing of the activation of the switch 202, the pull switch 202 returning to the non-active position, and/or the switch 202 failing to return to the non-active position can also be reported.

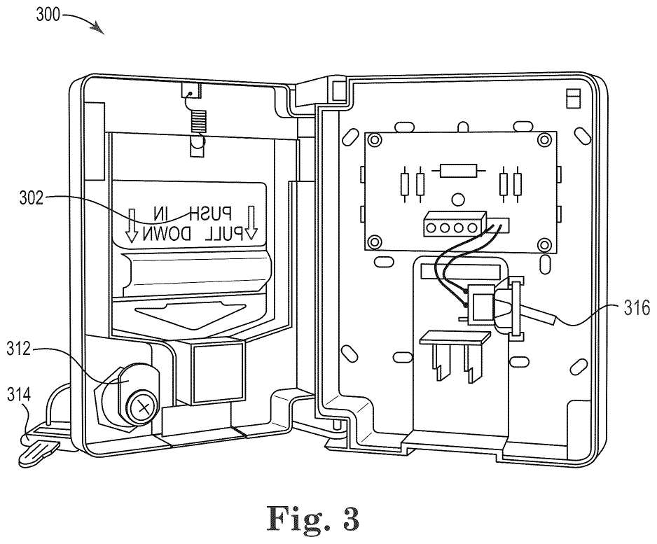

FIG. 3 illustrates an example of an interior of a self-testing initiating device 300 in accordance with an embodiment of the present disclosure. Initiating device 300 can correspond to initiating device 100 of FIG. 1 and/or initiating device 200 of FIG. 2. The initiating device 300 can include a switch 302, a keyhole 312, a key 314, and a switch 316. The switch 302 can correspond to switch 102 of FIG. 1 and switch 202 of FIG. 2.

In a number of embodiments, the initiating device 300 can be placed in a test mode and/or receive a test command, as previously described herein. In response to being placed in the test mode and/or receiving the command, an actuator (e.g., actuator 104 of FIG. 1) can activate to turn the key 314 in keyhole 312.

The initiating device 300 can be isolated from the other components (e.g., from the rest of) the fire alarm system in response to placing the initiating device 300 in the test mode. Isolating the initiating device 300 can prevent a false alarm. For example, activating the actuator to turn the key 314 of the initiating device 300 without first isolating the initiating device 300 could sound a fire alarm. As such, isolating the initiating device 300 from the rest of the fire alarm system prevents a fire alarm from sounding when activating the actuator to turn the key 314 of the initiating device 300.

Once the initiating device 300 has been tested, the initiating device 300 can be removed from the test mode and revert to a non-test (e.g., operational) mode to enable a user to activate a fire alarm (e.g., subsequent to removing the initiating device 300 from the test mode, a fire alarm can be activated in response to the user activating switch 302). For example, the initiating device 300 can be removed from the test mode in response to receiving a command to end the test mode. Further, the actuator can be activated to turn the key 314 of the initiating device 300 again in response to removing the initiating device 300 from the test mode. For instance, the key 314 can be turned in a first direction, for example a clockwise direction, to activate a fire alarm, actuate the switch 302 to an active position, and/or to test the initiating device 300 when in a test mode and the key 314 can be turned in a second direction, for example a counter-clockwise direction, to remove the initiating device 300 from the test mode and/or to return the switch 302 to the non-active position. Subsequent to removing the initiating device 300 from the test mode, a fire alarm can be activated in response to a user activating the switch 302 to toggle the switch 316.

In a number of embodiments, the turning of the key 314 can be reported. For example, the turning of the key 314 can be reported in response to the actuator turning the key 314. Further, a failure of the key 314 to turn can also be reported. For example, in response to the actuator failing to turn the key 314, the failure to turn the key 314 can be reported.

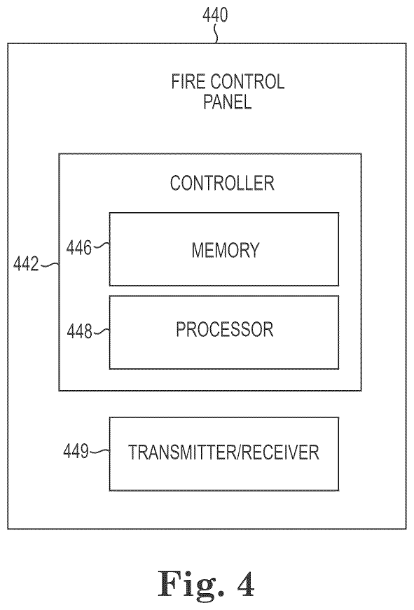

FIG. 4 illustrates a block diagram of a fire control panel (e.g., control panel) 440 in accordance with an embodiment of the present disclosure. The control panel 440 can be a monitoring device or a fire detection control system of a fire alarm system (e.g., the same fire alarm system that includes initiating device 100, 200, and/or 300). The control panel 440 can include a controller 442 and a transmitter/receiver 449.

The controller 442 can include a memory 446 and a processor 448. Memory 446 can be any type of storage medium that can be accessed by processor 448 to perform various examples of the present disclosure. For example, memory 446 can be a non-transitory computer readable medium having computer readable instructions (e.g., computer program instructions) stored thereon that are executable by processor 448 to communicate with an initiating device (e.g., initiating device 100, 200, and 300 in FIGS. 1, 2, and 3, respectively) in accordance with the present disclosure. For instance, processor 448 can execute the executable instructions stored in memory 446 to transmit a command to the initiating device. The command can be a command for the initiating device to enter a test mode and/or perform a test of the initiating device, as previously described herein. In some examples, the control panel 440 can transmit the command to the initiating device in response to receiving a command from a mobile device. The command can be transmitted via the transmitter/receiver 449.

In a number of embodiments, the control panel 440 can receive a report from the initiating device via the transmitter/receiver 449. The report can include whether an actuator (e.g., actuator 104 of FIG. 1) of the initiating device was able to turn a key (e.g., key 314 of FIG. 3) and/or actuate a switch (e.g., switch 102, 202, and 302 of FIGS. 1, 2, and 3, respectively) or failed to turn the key and/or failed to actuate the switch as part of a test of the initiating device. If the key was turned and/or the switch was actuated, the test of the initiating device can be determined to be successful. If the key failed to turn and/or the switch failed to actuate, the test of the initiating device can be determined to have failed.

The control panel 440 can transmit, via transmitter/receiver 449, another command to the initiating device. For example, the control panel 440 can transmit a command to end the test mode of the initiating device in response to receiving the report from the initiating device. If the test was successful, the control panel 440 can send a command to end the test mode to allow the initiating device to revert back to being enabled to activate a fire alarm. If the test failed, the control panel 440 can send a command to retry the test. The control panel 440 can be configured to send commands to and/or receive reports from a number of initiating devices or fire sensing devices via a wired or wireless network.

Although not illustrated in FIG. 4, in a number of embodiments, the control panel 440 can include a user interface. The user interface can be a GUI that can provide and/or receive information to and/or from a user and/or the initiating device. The user interface can display messages and/or data received from the initiating device. For example, the user interface can alert a user to a successful or failed test of the initiating device.

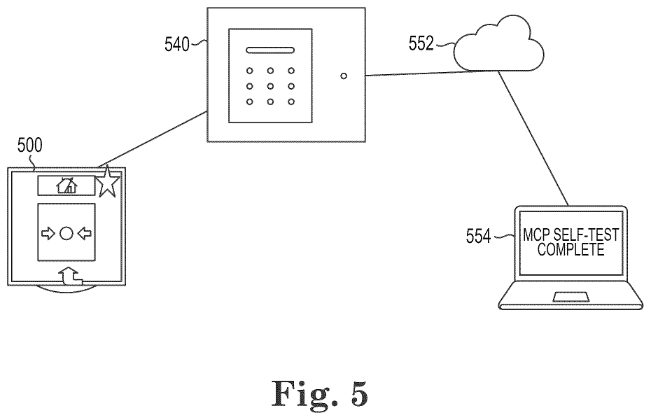

FIG. 5 illustrates a fire control system in accordance with an embodiment of the present disclosure. The fire control system can include a initiating device 500, a control panel 540, a cloud computing device 552, and a mobile device 554. The initiating device 500 can correspond to initiating device 100, 200, and 300 of FIGS. 1, 2, and 3, respectively. The control panel 540 can correspond to control panel 440 of FIG. 4.

The initiating device 500, the control panel 540, the cloud computing device 552, and the mobile device 554 can communicate with each other via a wired or wireless network. For example, the mobile device 554, the cloud computing device 552, and/or the control panel 540 can transmit a command (e.g., to enter test mode and/or perform a test) to the initiating device 500 via the network. In a number of embodiments, the initiating device 500 can transmit a report to the mobile device 554, the cloud computing device 552, and/or the control panel 540 via the network, and the mobile device 554 can display the report (e.g., the rest of the test), as illustrated in FIG. 5. The mobile device 554, the cloud computing device 552, and/or the control panel 540 can transmit commands to and receive reports from a number of initiating devices analogous to initiating device 500. For example, the mobile device 554 can transmit commands to each of a number of initiating devices analogous to initiating device 500 and receive reports from each of the number of initiating devices.

The networks described herein can be a network relationship through which initiating device 500, the control panel 540, the cloud computing device 552, and the mobile device 554 can communicate with each other. Examples of such a network relationship can include a distributed computing environment (e.g., a cloud computing environment), a wide area network (WAN) such as the Internet, a local area network (LAN), a personal area network (PAN), a campus area network (CAN), or metropolitan area network (MAN), among other types of network relationships. For instance, the network can include a number of servers that receive information from and transmit information to the initiating device 500, the control panel 540, the cloud computing device 552, and the mobile device 554 via a wired or wireless network.

As used herein, a “network” can provide a communication system that directly or indirectly links two or more computers and/or peripheral devices and allows a mobile device 554 to access data and/or resources on the initiating device 500, the control panel 540, the cloud computing device 552, and vice versa. A network can allow users to share resources on their own systems with other network users and to access information on centrally located systems or on systems that are located at remote locations. For example, a network can tie a number of computing devices together to form a distributed control network (e.g., cloud computing device 552).

A network may provide connections to the Internet and/or to the networks of other entities (e.g., organizations, institutions, etc.). Users may interact with network-enabled software applications to make a network request, such as to get data. Applications may also communicate with network management software, which can interact with network hardware to transmit information between devices on the network.

In some examples, the network can be used by the initiating device 500 and/or control panel 540 to communicate with the mobile device 554. The mobile device 554 can be a personal laptop computer, a smart phone, a tablet, a wrist-worn device, and/or redundant combinations thereof, among other types of computing devices. The mobile device 554 can receive reports from a number of initiating devices analogous to initiating device 500 and/or a number of control panels analogous to control panel 540 and transmit commands based on the reports to one or more of the number of initiating devices and/or one or more of the number of control panels.

In a number of embodiments, the control panel 540 can transmit a command to the initiating device 500. The initiating device 500 can receive the command and enter a test mode in response to receiving the command. In response to entering the test mode, the initiating device 500 can activate a switch (e.g., switch 102, 202, and 302 of FIGS. 1, 2, and 3, respectively) and/or a key (e.g., key 314 of FIG. 3) via an actuator (e.g., actuator 104 of FIG. 1) of the initiating device 500 to test the initiating device 500.

The initiating device 500 can transmit a report to the control panel 540 in response to activating the switch or the key via the actuator. In response to receiving the report, the control panel 540 can transmit a command to end the test mode to the initiating device 500. The initiating device 500 can end the test mode in response to receiving the command to end the test mode.

The control panel 540 can transmit a command to additional (e.g., different) initiating devices of the fire control system analogous to initiating device 500 to test those devices. The different initiating devices can each receive the command and enter the test mode in response to receiving the command. In response to entering the test mode, the different initiating devices can each activate a switch or a key via an actuator of the different initiating device, in a manner analogous to that previously described herein.

The different initiating devices can each transmit a report to the control panel 540 in response to activating or failing to activate the switch or the key via the actuator. In response to receiving a report of a failure, the control panel 540 can transmit a command to the initiating device from which the failure report was received to try to activate the switch or the key again. The different initiating device can attempt to activate the switch or the key again in response to receiving the command. In a number of embodiments, the control panel 540 can flag the failure by transmitting the failure to the cloud computing device 552 and/or the mobile device 554. The cloud computing device 552 can store the failure of the different initiating device in memory. The mobile device 554 can convey the failure of the different initiating device to a user to have someone go inspect the different initiating device to see if the different initiating device requires maintenance or replacement.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A self-testing manual initiating device, comprising:
a switch configured to activate a fire alarm system;
an actuator coupled to the switch configured to activate the switch; and
a controller configured to:
receive a command to test the self-testing manual initiating device; and
transmit a command to the actuator to activate the switch in response to receiving the command to test the self-testing manual initiating device.

2. The device of claim 1, wherein the self-testing manual initiating device is in test mode prior to the controller receiving the command to activate the switch.

3. The device of claim 2, wherein the controller is configured to receive a command to end the test.

4. The device of claim 3, wherein the controller is configured to transmit a command to the actuator to cease activation of the switch in response to receiving the command to end the test.

5. The device of claim 4, wherein the self-testing manual initiating device ceases the test mode in response to the actuator ceasing the activation of the switch and reverts the self-testing manual initiating device to a non-test mode to enable a user to activate the fire alarm.

6. The device of claim 1, wherein the actuator is a solenoid, a linear actuator, a non-linear actuator, a servo motor, or a stepper motor.

7. A method of operating a self-testing manual initiating device, comprising:
placing the self-testing manual initiating device in a test mode; and
activating an actuator of the self-testing manual initiating device to turn a key of the self-testing manual initiating device in response to placing the self-testing manual initiating device in the test mode.

8. The method of claim 7, further comprising isolating the self-testing manual initiating device in response to placing the self-testing manual initiating device in the test mode.

9. The method of claim 8, further comprising preventing a fire alarm from sounding when activating the actuator to turn the key of the self-testing manual initiating device in response to isolating the self-testing manual initiating device.

10. The method of claim 7, further comprising removing the self-testing manual initiating device from the test mode in response to receiving a command to end the test mode.

11. The method of claim 10, further comprising activating the actuator to turn the key of the self-testing manual initiating device again in response to removing the self-testing manual initiating device from the test mode.

12. The method of claim 11, further comprising activating a fire alarm in response to a user activating a switch of the self-testing manual initiating device subsequent to removing the self-testing manual initiating device from the test mode.

13. The method of claim 7, further comprising reporting the turning of the key of the self-testing manual initiating device in response to the actuator turning the key.

14. The method of claim 7, further comprising reporting a failure to turn the key of the self-testing manual initiating device in response to the actuator failing to turn the key.

15. A fire control system, comprising:
a control panel configured to transmit a command to a self-testing manual initiating device of the fire control system; and
the self-testing manual initiating device configured to:
receive the command;
enter a test mode in response to receiving the command; and
activate a switch or a key via an actuator of the self-testing manual initiating device to test the self-testing manual initiating device in response to entering the test mode.

16. The system of claim 15, wherein the control panel is configured to transmit the command to test the self-testing manual initiating device in response to receiving a command from a mobile device.

17. The system of claim 15, wherein the self-testing manual initiating device is configured to transmit a report to the control panel in response to activating the switch or the key via the actuator.

18. The system of claim 17, wherein the control panel is configured to transmit a command to end the test mode to the self-testing manual initiating device in response to receiving the report from the self-testing manual initiating device.

19. The system of claim 18, wherein the self-testing manual initiating device is configured to end the test mode in response to receiving the command to end the test mode.

20. The system of claim 15, wherein:
the control panel is configured to transmit a command to test a different self-testing manual initiating device of the fire control system; and
the different self-testing manual initiating device is configured to:
receive the command;
enter the test mode in response to receiving the command; and
activate a switch or a key via an actuator of the different self-testing manual initiating device to test the different self-testing manual initiating device in response to entering the test mode.
